(19) United States
(12) Patent Application Publication
(10) Pub. No.: US 2023/0415398 A1
(43) Pub. Date: Dec. 28, 2023

(54) MANIFOLD PLATE, MANIFOLD COMPRISING A MANIFOLD PLATE, EXTRUSION ASSEMBLY COMPRISING A MANIFOLD, AND METHOD OF MAKING A MANIFOLD PLATE

(71) Applicant: W. Müller GmbH, Troisdorf (DE)

(72) Inventors: Thomas WOLF, Troisdorf (DE); Jürgen MOSLER, Neunkirchen-Seelscheid (DE)

(73) Assignee: W. Müller GmbH, Troisdorf (DE)

(21) Appl. No.: 18/362,035

(22) Filed: Jul. 31, 2023

Related U.S. Application Data
(63) Continuation of application No. PCT/EP2022/051547, filed on Jan. 25, 2022.

(30) Foreign Application Priority Data
Feb. 1, 2021 (EP) 21154623

(51) Int. Cl. B29C 48/305; B29C 48/30; B29C 48/335; B29C 48/495

(52) U.S. Cl. CPC B29C 48/307; B29C 48/3001; B29C 48/335; B29C 48/495

(57) ABSTRACT

A manifold plate for a manifold for supplying thermoplastic plastic melt to at least one extrusion head for producing a preform is disclosed. The manifold plate includes: a first plate side and a second plate side, a distribution groove incorporated in the first plate side and extending in a plate plane of the first plate side, and at least one connecting channel adjoining the distribution groove, which is worked into the manifold plate and ends at an outlet opening in the second plate side. The manifold plate is characterized in that the at least one connecting channel is milled into the manifold plate and, in the flow direction, has a course which is curved at least in sections towards the second plate side. A manifold, an extrusion assembly and a method for manufacturing a manifold plate are also disclosed.

### CROSS-REFERENCE TO RELATED APPLICATIONS

This application is a continuation of International Application No. PCT/EP2022/051547, filed on Jan. 25, 2022, which claims priority to and the benefit of EP 21154623 filed on Feb. 1, 2021. The disclosures of the above applications are incorporated herein by reference.

### FIELD

The present disclosure relates to a manifold plate for a manifold for supplying thermoplastic plastic melt to at least one extrusion head for producing a preform, in particular a tubular preform. The manifold plate includes a first plate side and a second plate side, a distribution groove formed in the first plate side and extending in a plate plane of the first plate side, and at least one connecting channel adjoining the distribution groove and formed in the manifold plate and terminating at an outlet opening in the second plate side. The present disclosure further relates to a manifold having at least one manifold plate. Such a manifold can also be called a melt distributor. Further, the present disclosure relates to an extrusion assembly including the manifold, and a method of manufacturing the manifold plate.

### BACKGROUND

The statements in this section merely provide background information related to the present disclosure and may not constitute prior art.

U.S. Pat. No. 3,561,053A discloses a melt distributor having two manifold plates that abut against each other along a parting plane. A distribution network for distributing thermoplastic plastic melt to four mass outlets extends in the parting plane, with the melt conveyed by an extruder being fed into the distribution network via a central mass inlet. The distribution network has distribution channels incorporated into the facing first plate sides of the manifold plates and fed by a central main channel. The distribution channels, in turn, are each divided into two connecting channels, each of which ends at one of the mass outlets. However, because the distribution network is formed exclusively in the parting plane, the manifold or manifold plates are only suitable for producing single-layer preforms.

Melt distributors for the production of multilayer preforms are also known from the prior art. Manifolds of this type have a plate pack with several manifold plates, each of which rests against each other along a horizontal parting plane. Distribution channels extend in the respective parting plane and are incorporated as grooves in facing sides of the manifold plates. The ends of the distribution channels are connected to inlet and outlet holes drilled perpendicular to the parting plane, which connect the distribution channels to the inlet and outlet openings of the plate pack. It is considered disadvantageous that flow dead zones are created at the transitions between the distribution channels and the bores, in which the plastic melt accumulates and can only flow off after a certain, possibly longer, residence time. This is particularly problematic in the case of color or material changes, as it increases the changeover time and thus the number of scrap.

DE 10 2019 009 151 B3 discloses a melt distributor made of a one-piece component. The melt distributor is manufactured using a moldless additive manufacturing process for metallic materials. Due to the 3D manufacturing, the transitions between pipes via which the plastic melt is fed to the outlet openings can be formed rounded, i.e. not straight. This is to avoid flow dead zones. This additive manufacturing offers a great deal of geometrical freedom. However, it is perceived as a disadvantage that the surface of the piping is stepped or rough due to the layered structure inherent in the additive manufacturing process, which can increase the cleaning effort of the melt distributor.

DE 10 2019 009 151 B3 also describes prior art in which trouser-shaped pipelines each divide a melt stream into two different melt streams. For this purpose, a rectilinear feeding pipeline section in the form of a bore is arranged in an upper plate. In a lower plate, two straight diverting pipeline sections are arranged in the form of bores, which are connected to the respective feeding pipeline section via channels. Half of the channels are milled into the upper plate and half into the lower plate in the parting plane. Thus, a rectilinear feeding pipeline section and the two rectilinear discharging pipeline sections connected to it result in a trouser-shaped pipeline.

### SUMMARY

This section provides a general summary of the disclosure and is not a comprehensive disclosure of its full scope or all of its features.

One object of the invention is to provide a manifold plate in which flow dead zones are avoided and which is easy to clean. It is further an object of the invention to provide a manifold in which flow dead zones are avoided and which is easy to clean. Furthermore, one object of the invention is to provide an improved extrusion assembly that avoids flow dead zones and is easy to clean. Furthermore, it is an object of the invention to provide a method of manufacturing a manifold plate that avoids flow dead zones and is easy to clean.

One solution is a manifold plate of the type mentioned above, in which the at least one connecting channel is milled into the manifold plate and has a at least partially curved course in the flow direction towards the second plate side.

The thermoplastic plastic melt can flow through the distribution groove and the at least one connecting channel. It is advantageous that the at least one connecting channel deflects thermoplastic plastic melt flowing from the distribution groove into the at least one connecting channel to the respective outlet opening as uniformly and continuously as possible during operation. This is because, in contrast to drilling, where the drilling tool cuts only in the direction of its axis of rotation, milling allows the milling tool to be used perpendicularly or at an angle to its axis of rotation. Thus, the at least one connecting channel provides a rounded transition from the distribution groove extending in the plate plane of the first plate side and through the manifold plate to the outlet opening at the second plate side of the manifold plate. Flow dead zones in the melt flow are avoided and scrap is reduced during color or material changes. In addition, milled channel walls have a smooth channel wall throughout, further reducing the amount of cleaning required of the manifold plate and, consequently, scrap.

In the following, “the at least one connecting channel” will be abbreviated to “the connecting channel” for the sake of better readability, and it will continue to apply that exactly the one connecting channel or several of the connecting channels, for example two, three, four, five or six of the connecting channels, can be connected to the distribution groove. Each connecting channel ends at its own outlet opening, which is formed in the second plate side of the manifold plate, so that the thermoplastic plastic melt flowing through the at least one connecting channel during operation can exit the manifold plate at the respective outlet opening.

The connecting channel can define a course line. In other words, the course of the connecting channel, respectively the channel course can extend along the course line. In particular, the course line is a continuous line that can have curved or arcuate and straight sections. By extending through the manifold plate, the connecting channel can have at least one section in which the connecting channel is closed in the circumferential direction around the course line.

The connecting channel can have a curved section, the course line in the curved section being curved in the flow direction towards the second plate side. In particular, the course line in the curved section is continuously curved and does not have an undulating course. The curvature is non-zero at every point in the curved section. In this case, the curvature can vary along the sectionally curved course line, but it cannot be zero. In principle, the curvature at any point in the curved section can also be the same if the course line follows a circular arc section. In idealization, the course line of the connecting channel in the curved section follows a circular arc section. If the second plate side is aligned parallel to the first plate side, the arc section can extend over an angle of 90 degrees, i.e., a quarter circle.

Furthermore, the curved section of the at least one connecting channel can be designed on the inlet side as a groove open perpendicular to the course line and on the outlet side, or downstream of the groove, as a duct closed in the circumferential direction around the course line. In a sense, the connecting channel dips into the manifold plate in the curved section. A groove bottom along the groove-shaped partial section of the curved section can have a groove bottom that is curved, in particular continuously, in the flow direction at least in sections toward the second plate side.

The partial section of the curved section, which is designed as a groove and is open towards the plate plane of the first plate side, simplifies the manufacture of the manifold plate. This is because when the connecting channel is worked into the manifold plate, a clamping shaft of the milling tool can, depending on its alignment to the plate plane, collide with edges of the manifold plate, which can disrupt or prevent further, or deeper, immersion into the manifold plate. Such plate edges can also be referred to as interfering edges.

Furthermore, it can be provided that the at least one connecting channel has an inlet section upstream of the curved section, which extends in the plate plane of the first plate side. The connecting channel can thus connect to the distribution groove without interruption or steplessly. Preferably, the connecting channel directly adjoins the distribution groove. This avoids flow dead zones. In the inlet section, the course line extends parallel to the plate plane of the first plate side and has the curved course in the curved section. The connecting channel thus deflects the thermoplastic plastic melt flowing through the distribution groove into the connecting channel during operation from the plate plane of the first plate side towards the second plate side, so that the plastic melt can exit the manifold plate from the outlet opening.

The inlet section can be formed as a groove open to the plate plane of the first plate side, respectively as a groove open perpendicular to the course line, which makes the manifold plate easier to manufacture. This allows the milling tool to be guided to the manifold plate at a steeper angle to the plate plane when producing the connecting channel and to plunge deeper into the manifold plate. Preferably, the depth of the inlet section formed as a groove corresponds to the depth of the distribution groove in order to ensure an even, respectively stepless transition from the distribution groove into the connecting channel. Preferably, the depth of the distribution groove is constant over its entire course. In particular, the distribution groove may extend exclusively in the plate plane of the first plate side.

Preferably, the connecting channel is designed to be closed in the circumferential direction around the course line downstream of the partial section of the curved section designed as a groove. The course line can correspond to the course line of the connecting channel in the circumferentially closed section of the connecting channel. Preferably, the connecting channel has an elliptical, in particular circular, contour in the circumferentially closed section. The circumferentially closed channel walls of the connecting channel can be arranged concentrically to the course line.

In order to further simplify the manufacture of the manifold plate, in particular the milling of the connecting channel into the workpiece from which the manifold plate is manufactured, it can be advantageous if a tangent at the course line in the curved section encloses an angle of greater than 0 degrees and less than 60 degrees with the plate plane. In particular, this can apply in the curved section to any point on the course line.

Furthermore, the connecting channel can have a further curved section downstream of the curved section, in which the course line is curved in the flow direction towards the second plate side. In a preferred manner, the further curved section is formed closed in the circumferential direction around the course line. A tangent applied to the course line in the further curved section can include an angle of 90 degrees maximum and greater than 30 degrees with the plate plane of the first plate side. In particular, this can apply to any point on the course line in the further curved section.

Furthermore, a transition section may be formed between the first curved section and the second curved section, in which the course line is straight. The connecting channel can be cylindrical in the transition section. The course line along the transition section may include an angle greater than 0 degrees and less than 60 degrees with the plate plane.

The connecting channel can have an outlet section ending at the outlet opening, whereby the course line in the outlet section can be straight and can extend transverse to the first plate side. In a preferred manner, the outlet section is formed closed in the circumferential direction around the course line. In particular, an imaginary extension of the course line in the outlet section may include an angle of 45 degrees to 90 degrees with the plate plane of the first plate side. This allows the position and contour of the outlet opening in the second plate side to be adapted to structural specifications. These may result, for example, from the fact that a manifold comprising the at least one manifold plate has a plurality of superimposed plates whose channels have to be interconnected, and/or from the fact that the manifold has to be integrated into an extrusion assembly in which the spatial arrangement of the fluid-conducting interfaces is predetermined.

According to one embodiment, the course line in the outlet section is straight and may be perpendicular to the plate plane of the first plate side and/or perpendicular to a plate plane of the second plate side. The first plate side and the second plate side can be parallel to each other. This allows the connecting channel to deflect the thermoplastic plastic melt flowing into the connecting channel via the distribution groove by 90 degrees. The connecting channel can be cylindrical in the outlet section and the outlet opening can be circular. If the manifold plate is to be reworked after the connecting channel has been milled, it can be advantageous if the outlet section, starting from the outlet opening or the second plate side, extends up to 2.5 millimeters into the manifold plate. Preferably, the outlet section extends a maximum of 2 millimeters into the manifold plate. The finishing operation may include, for example, face milling or polishing of the second plate side, with the outlet opening still retaining its circular contour due to the cylindrical outlet section, as long as a portion of the outlet section is still left standing.

According to a further embodiment, the outlet section of the connecting channel can also merge into the outlet opening at an angle to the second plate side. This can be advantageous, for example, if the manifold plate is designed to produce a multilayer preform in order to be able to arrange the connections in the limited installation space. Preferably, the course line in the outlet section is straight. In particular, an angle of less than 90 degrees and/or greater than 0.5 degrees is formed between the course line in the outlet section and the plate plane of the first plate side. Preferably, this angle is about 10 degrees to 80 degrees. The outlet opening may be in the shape of an ellipse or even a circle if the outlet opening is oriented obliquely to the second plate side.

Furthermore, it can be provided that the connecting channel has a constant flow cross-section. In particular, the flow cross-section of the connecting channel along the circumferentially closed line section can be an elliptical surface, or a circular surface.

The manifold plate can have a basic shape that is at least approximately cuboidal. The first plate side and the second plate side may be outer sides of the manifold plate facing away from each other. The first plate side and the second plate side can be parallel to each other. This allows the manifold plate to be easily stacked with other manifold plates or other plates of a manifold. In principle, however, the second plate side can also be arranged at an angle to the first plate side. The first plate side may be a top side and the second plate side may be a bottom side of the manifold plate, if the manifold plate is arranged horizontally.

Preferably, the manifold plate is made of a solid material, especially a metallic one. This allows a particularly stable manifold plate with a long operating life. The manifold plate can be made of a quenched and tempered tool steel, for example. The metallic manifold plate can be easily milled so that the connecting channel can be provided with a particularly smooth channel wall. In order to achieve a specified surface finish for the channel wall, the surface of the connecting channel can be roughened or finished, in particular finely finished. Preferably, the surface of the channel wall may have a mean roughness index Ra of no more than 3.2 micrometer and more preferably about 1.6 micrometer. After milling work, the channel wall of the connecting channel may have been polished. Accordingly, the mean roughness index Ra of the surface of the channel wall can be not more than 0.8 micrometer and can be preferably between 0.4 micrometer and 0.025 micrometer. Good results were obtained with the surface finish, whose mean roughness index Ra is at least approximately 0.1 micrometer. This makes the manifold plate easier to clean and reduces scrap. For example, the thickness of the manifold plate can range from 20 millimeters to 100 millimeters. Preferably, the plate thickness is about 30 millimeters to 75 millimeters.

In a preferred manner, exactly two of the connecting channels into which the distribution groove is divided, respectively branched, adjoin the distribution groove. Accordingly, the two connecting channels can also be referred to as branch channels. Preferably, the connecting channels spread from each other in the shape of pants starting from the distribution groove. The course lines of the two connecting channels are curved in the flow direction, at least in sections towards the second plate side, resulting in the approximate shape of a seated pair of trousers. Since the inlet sections of the two connecting channels can extend in the plate plane and can be designed to be open towards the first plate side, the transition from the distribution groove to the inlet sections of the two connecting channels can be achieved with the milling tool without any obstacles. The transition can be milled into the manifold plate as a symmetrical, in particular y-shaped branch. The branch is preferably rounded. In this way, flow dead zones in the transition are avoided.

In a very preferred manner, the manifold plate has a plurality of the distribution grooves. For each extrusion head, the manifold plate can have one of the distribution grooves, to which only one or two of the connecting channels can be connected. For an example of ten extrusion heads, the manifold plate would be able to have ten of the distribution grooves accordingly. In principle, however, several of the distribution grooves can also supply one of the extrusion heads. This is especially advantageous for larger extrusion heads. For example, two or three distribution grooves can be provided for each extrusion head, which in turn can each branch into one, two, three, four, five or six connecting channels.

Preferably, the distribution grooves incorporated on the first plate side belong to a distribution network that is coherent in itself. The distribution network can have a mass inlet on the input side for connection to an extruder in order to be able to extrude a single-layer preform by means of the manifold plate. In order to be able to extrude multi-layer preforms by means of the manifold plate, a second distribution network can extend over the manifold plate, which is independent of the first distribution network and has no fluid-conducting connection to it. For this purpose, for example, further distribution grooves can be formed in the second plate side, to which in turn connecting channels can be connected, which can be formed in a further manifold plate. The distribution grooves in the first plate side and the further distribution grooves in the second plate side can be arranged one above the other. The entrance areas of the connecting channels adjoining the distribution grooves can spread further apart from each other in the first plate side than the entrance areas of the further connecting channels adjoining the further distribution grooves in the second plate side. In this way, a particularly compact manifold plate can be provided.

The problem is further solved by a manifold for supplying thermoplastic plastic melt to at least one extrusion head for producing a preform, wherein the manifold comprises at least one pre-described manifold plate and a cover plate. The manifold according to the invention results in the same advantages as described in connection with the manifold plate according to the invention, so that reference is made here to the above description by way of abbreviation. It is understood that all the above-mentioned embodiments of the manifold plate can be transferred to the manifold and vice versa. Overall, the manifold is easier to clean and scrap after a color or material change is reduced.

Preferably, the at least one manifold plate and the cover plate are combined into a plate pack in which the plates are arranged one above the other. The distribution groove formed in the at least one manifold plate may be covered by the adjacent plate. In particular, the distribution groove machined into the manifold plate is covered by a distribution groove machined into the adjacent plate. Thus, the two distribution grooves arranged one above the other can together form a distribution channel. The distribution channel can have a channel centerline, which can be located in the parting plane between the two plates if the two superimposed distribution grooves are symmetrical. This gives the distribution channel a closed channel wall in the circumferential direction around the channel centerline of the distribution channel. The two distribution grooves arranged one above the other can be the same size in cross-section relative to the channel centerline. In principle, the adjacent plate can also have a smooth, flat plate side, i.e. have no distribution groove, whereby the channel centerline of the distribution groove is not in the parting plane but in the distribution groove of the manifold plate.

In the simplest embodiment, when the manifold is designed to extrude a single-layer preform, the manifold may comprise a plate pack with two plates, namely the manifold plate and the cover plate, which may abut against each other along the plate plane, respectively the parting plane. For each extrusion head, the manifold can have a distribution channel to which one or two of the connecting channels can be connected.

The manifold may have a plate pack with a plurality of the manifold plates, which may be arranged one on top of the other. The respective adjacent manifold plates may abut against each other along the respective plate plane, with the second plate side of one manifold plate in contact with the first plate side of the other manifold plate. The cover plate can close off the plate pack, in particular on a side facing away from the at least one extrusion head.

By means of the manifold, a preform with at least one layer can be extruded. For each layer, the manifold can have a continuous distribution network which has a mass inlet for a material stream of thermoplastic plastic melt conveyed by an extruder, at least one mass outlet for each extrusion head and, in the flow direction of the material stream between the mass inlet and the mass outlets, one of the distribution channels for each extrusion head. Using the example of a two-layer extruder, the manifold may have a first distribution network for the first layer and a second distribution network for the second layer, which exist independently of each other and are not interconnected. By arranging several of the manifold plates one above the other, further distribution networks, in particular a third, fourth, fifth and/or sixth distribution network, can be built up in order to be able to extrude correspondingly multilayer, in particular up to six-layer, preforms with the at least one extrusion head.

The problem is further solved by an extrusion assembly comprising a manifold as described above and at least one extrusion head for producing a preform. The extrusion assembly according to the invention results in the same advantages as described in connection with the manifold according to the invention, so that reference is made here to the above description by way of abbreviation. It is understood that all of the aforementioned embodiments of the manifold are transferable to the extrusion assembly and vice versa. Overall, the extrusion assembly is easier to clean and scrap after a color or material change is reduced.

The extrusion assembly may include at least one extruder located upstream of the manifold. To produce multi-layer preforms, the extrusion assembly can have one of the extruders per layer.

The object is further obtained by a method for manufacturing the aforementioned manifold plate, the method comprising the steps of: Working the distribution groove into a first plate side of a workpiece, and working the at least one connecting channel into the workpiece by path-controlled form milling, wherein a milling head is moved starting from the first plate side at least in sections on a path curved towards the second plate side. The method according to the invention results in the same advantages as described in connection with the manifold plate according to the invention or the manifold according to the invention or the extrusion assembly according to the invention, so that reference is made here to the above description by way of abbreviation. It goes without saying that all of the above-mentioned designs of the manifold plate or manifold or extrusion assembly can be transferred to the method and vice versa. Overall, the method allows manufacturing of a manifold plate that avoids flow dead zones and is easy to clean.

The workpiece may already have the basic shape of the finished manifold plate. To manufacture the manifold plate, the distribution groove and the at least one connecting channel are worked into the workpiece. The first plate side or the second plate side of the workpiece thus becomes the first plate side or the second plate side of the manifold plate.

The milling tool may comprise a conventional milling cutter having a base body with a clamping shaft and working area. The clamping shaft is clamped in a receptacle of a spindle of a machine tool. The spindle defines a spindle axis around which the milling tool can be rotationally driven by the machine tool. The workpiece can be milled with the work area or milling head of the milling tool.

The milling head can be spherical. Preferably, a diameter of the milling head is smaller than a channel diameter of the connecting channel to be produced so that the milling head can cut itself free. This allows a uniformly curved connecting channel to be produced. To ensure radial feeding of the milling head, the milling cutter center path can be helical. The spiral movement prevents the milling head from touching the workpiece with its front face. If the milling cutter is adjusted slightly, the plunge angle can be changed.

Path-controlled form milling can be trochoidal milling or wobble milling. In this way, the milling head can plunge deeper into the workpiece past interfering edges and with a larger curved path. It is advisable that the milling head does not plunge vertically into the workpiece when milling the connecting channel along the at least partially curved course line. Rather, the plunging motion can be on an inclined or flat path, respectively, with respect to the plate plane. The angle between the spindle axis and the plate plane or the first or second plate side can be between 15 degrees and 165 degrees.

Furthermore, a first section of the connecting channel starting from the first plate side and a second section of the connecting channel starting from the second plate side can be machined into the workpiece by path-controlled form milling. As a result, it may be necessary to reclamp the workpiece, so that the manifold plate can sometimes not be produced in a single clamping operation. However, this also allows larger plate thicknesses to be machined, improving the stability and durability of the manifold plate. This production-related subdivision of the connecting channel into the first section and the second section can in principle also be advantageous for thinner manifold plates. However, the reclamping of the workpiece does not represent a disadvantage in the manufacturing process, especially if distribution grooves for a further distribution network are also machined into the second plate side of the manifold plate. The first section may include the inlet section and the (first) curved section. The second section may include the further, or second, curved section and the outlet section. The two curved sections can be directly adjacent to each other or merge into each other. If the connecting channel has the transition section, it may be located in the first section and/or the second section of the connecting channel.

Preferably, a CNC-controlled milling machine will be used for path-controlled form milling. “CNC” stands for “Computerized Numerical Control”. The CNC-controlled milling machine can be used not only for the connecting channel, but also for the other channels or grooves in the manifold plate. In path control, several axes are moved simultaneously. In this process, the milling tool is guided along a programmed toolpath at a preset speed. For this purpose, the milling machine can be a CNC machining center that allows machining in at least five axes. This allows the curved geometry of the connecting channel to be machined into the workpiece while maintaining consistently accurate dimensions.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a manifold plate according to one embodiment of the present invention in a top perspective view from oblique above;

FIG. 2 shows a top perspective view of the manifold plate from FIG. 1, with hidden body edges shown;

FIG. 3 is a sectional view of the manifold plate of FIG. 1 along line Ill-Ill shown in FIG. 1;

FIG. 4 shows a partial step of a method for manufacturing the manifold plate of FIG. 1 according to an embodiment of the present invention, in which a milling tool works a connecting channel into the manifold plate;

FIG. 5 shows the partial step from FIG. 4 in enlarged partial representation, whereby different working positions are shown to illustrate the relative movement between the milling tool and the manifold plate;

FIG. 6 shows a manifold according to one embodiment of the present invention in a top perspective view from oblique above, with hidden body edges shown;

FIG. 7 is a sectional view of the manifold shown in FIG. 6 along lines VII-VII of FIG. 6;

FIG. 8 is a top perspective view of the manifold shown in FIG. 6, with the outer edges of the manifold plates not shown to illustrate distribution networks extending across the manifold plates;

FIG. 9 is a perspective view from below of the distribution networks of FIG. 8 extending over the manifold plates;

FIG. 10 is a perspective view of an extrusion assembly according to one embodiment of the present invention, viewed obliquely from below; and

FIG. 11 is a sectional view of the extrusion assembly of FIG. 10 along the line XI-XI shown in FIG. 10.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

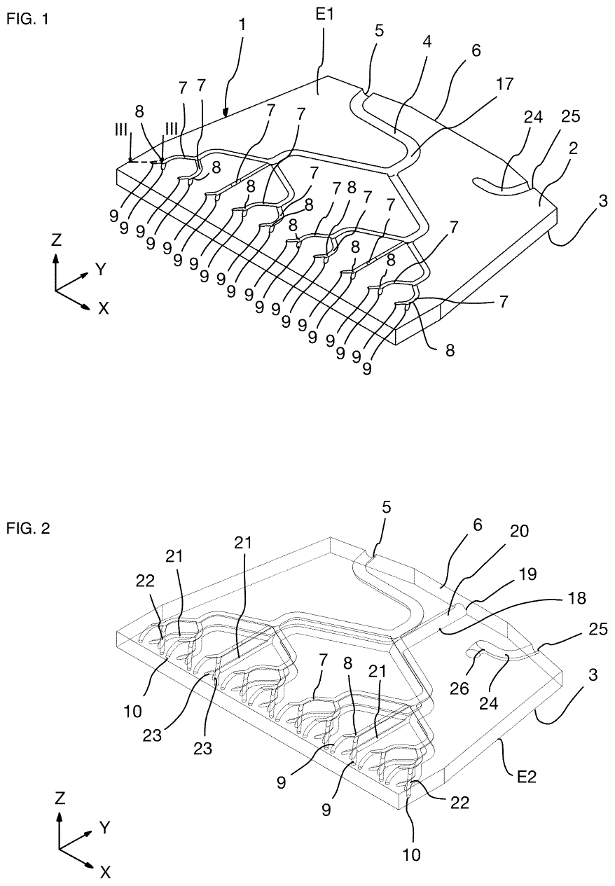

FIGS. 1 to 3 show a manifold plate 1 for a manifold for supplying thermoplastic plastic melt to at least one extrusion head for producing a preform for a melt distributor according to one embodiment.

To clarify the orientation of the manifold plate 1 in space, spatial axes X, Y, Z are defined in terms of a Cartesian coordinate system associated with the manifold plate 1 and indicated by corresponding arrows. The manifold plate 1 extends with its width along a spatial axis X, its depth along a spatial axis Y, and its height along a spatial axis Z.

The manifold plate 1, which is in particular metallic, can have an at least approximately cuboidal basic shape. The manifold plate 1 has a first plate side 2 and a second plate side 3 facing away from the first plate side 2. The two plate sides 2, 3 each define a plate plane E1, E2, which can be aligned parallel to each other. The plate planes E1, E2 are parallel to a plane spanned by the two spatial axes X, Y.

FIG. 1 shows that an inlet groove 4 is machined into the first plate side 2, through which a thermoplastic plastic melt can flow in a flow direction. The inlet groove 4 starts at a first mass inlet 5, to which a first extruder can be connected. The mass inlet 5 is formed in a front face 6 of the manifold plate 1, which may be oriented perpendicular to both plate sides 2, 3. In the flow direction, the inlet groove 4 in the first plate plane E1 branches in a tree-like structure into several, here exemplarily ten, distribution grooves 7, which are milled into the first plate side 2. The distribution grooves 7 each branch at a branch point 8 into two connecting channels 9, which are milled into the manifold plate 1. The connecting channels 9 begin in the first plate plane E1 and each end at an outlet opening 10, the outlet openings 10 being arranged in the second plate side 3.

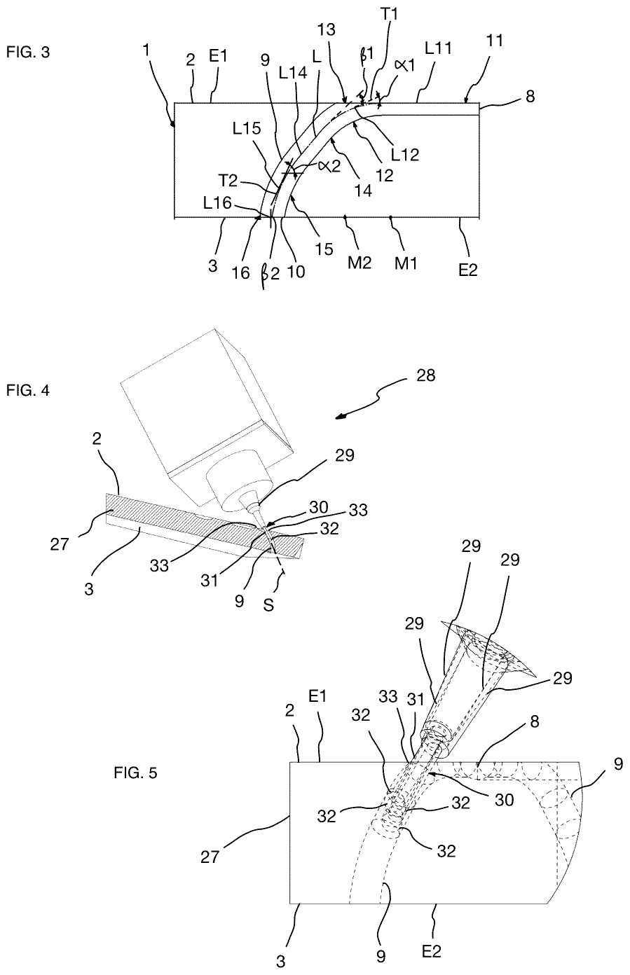

The connecting channels 9 each define a course line L which is curved in the flow direction at least in sections towards the second plate side 3. FIG. 3 shows the course of one of the connecting channels 9, which is exemplary for the course of all connecting channels 9. The course of the connecting channels 9 is explained below with reference to FIG. 3.

The connecting channel 9 has an inlet section 11 into which the associated distribution groove 7 opens. It can be seen in FIG. 1 that the connecting channels 9 spread out from each other in pairs in the flow direction, starting from the respective branch point 8, so that the course line L in the inlet section 11 has a course L11 that is curved in the first plate plane E1. The inlet section 11 is designed as a groove open to the first plate plane E1, respectively perpendicular to the course line L11. The groove depth of the inlet section 11 corresponds to the groove depth of the distribution groove 7.

The inlet section 11 is followed in the flow direction by a first curved section 12 of the connecting channel 9, in which the course line L from the plate plane E1 has a course L12 that is continuously curved in the flow direction towards the second plate side E2. In the first curved section 12, the course line L follows an arc section at least in an idealized manner. This can be, as shown here as an example, an eighth circle, whose circle center M1 lies in the second plate plane E2. Accordingly, a tangent T1 at the course line L in the first curved section 12 can enclose a first tangent angle α1 of greater than 0 degrees and, here exemplarily, a maximum of 45 degrees, with the first plate plane E1. This applies along the first curved section 12 for each point on the course section L12 of the course line L. FIG. 3 also shows that a partial section 13 of the first curved section 12 on the inlet side is designed as a groove open towards the first plate plane E1, or perpendicular to the course line L, which has a groove bottom curved in the flow direction towards the second plate side 3. The groove-shaped section 13 joins the groove-shaped inlet section 11 without interruption. The inlet-side section 13 extends in the flow direction over at least approximately half of the first curved section 12. Downstream of the inlet section 13, the connecting channel 9 is continuously closed in the circumferential direction around the course line L, i.e., in the form of a pipe.

The first curved section 12 is followed by a transition section 14 in the flow direction, in which the course line L has a straight course L14. The transition section 14 may also be referred to as the intermediate section. An imaginary extension of the section L14 of the course line L, which extends in a straight line in the transition section 14, encloses a first angle β1 with the first plate plane E1. The first angle β1 is, here exemplarily, 45 degrees.

The transition section 14 is followed by a second curved section 15 in the flow direction, in which the course line L has a curved course L15 from the straight course L14 in the transition section 14 in the flow direction towards the second plate side E2. In FIG. 3, it is shown that the course line L in the second curved section 15 follows an arc section at least in an idealized manner. This can be, as shown here as an example, an eighth circle, whose circle center M2 lies in the second plate plane E2. Accordingly, a tangent T2 to the course line L in the second curved section 15 may enclose with the first plate plane E1 a second tangent angle α2 of, here exemplarily, greater than or equal to 45 degrees and less than 90 degrees. This applies along the second curved section 15 for each point on the course line L. For clarity, an auxiliary line is drawn to represent the second tangent angle α2, which extends parallel to the first plate plane E1. The second circle center M2 is located in the second plate plane E2 between the first circle center M1 and the outlet opening 10 of the connecting channel 9. The distance between the two circle centers M1, M2 corresponds at least approximately to the extension of the transition section 12 in the flow direction.

An outlet section 16 of the connecting channel 9 adjoins the second curved section 15 in the flow direction. The outlet section 16 ends at the outlet opening 10. In the outlet section 16, the course line L again has a rectilinear course L16 and encloses a second angle β2 of, here exemplarily, 90 degrees with the first plate plane E1. The outlet opening 10 is correspondingly circular. Due to the infinitesimally small extension of the outlet section 16 in the flow direction shown here, the two circle centers M1, M2 lie in the second plate plane E2. Especially if the second plate side 3 is to be mechanically reworked, it can be advantageous if the outlet section 16 has a greater rectilinear extension in the flow direction. Then the two circle centers M1, M2 can be offset by the length of the outlet section 16 from the second plate plane E2 toward the first plate plane E1.

The course of the connecting channels 9 branching off in pairs from the associated distribution groove 7 resembles the shape of a pair of seated trousers, as can be seen in FIG. 2, thus avoiding flow dead zones. In principle, however, it is also possible for only one connecting channel 9 to be connected to the respective distribution groove 7, which can correspond to the course shown in FIG. 3, in which case the course line L in the inlet section 11 can have a straight course in the first plate plane E1, thus avoiding flow dead zones.

The grooves 4, 7 machined into the first plate side 2 of the manifold plate 1 as well as the connecting channels 9 belong to a contiguous distribution network 17, which can be connected to an extruder on the inlet side via the mass inlet 5. Each distribution groove 7 supplies an extrusion head with a partial flow of the thermoplastic plastic melt via the connected connecting channels 9, here exemplarily two. In the embodiment shown here, the manifold plate 1 can thus divide the thermoplastic plastic melt flowing in during operation via the first mass inlet 5 into twenty strands, to which ten extrusion heads can be supplied here as an example. It goes without saying that the manifold plate 1 can also have fewer or more than ten of the distribution grooves 7, respectively fewer or more than twenty of the connecting channels 9.

In FIG. 2, it can be seen that further grooves are machined, or milled, in the second plate side 3 of the manifold plate 1, which can be used as channel upper parts to cover the grooves 4, 7 formed in a first plate side 2 of a further manifold plate 1 which can be arranged thereunder, as well as the groove-shaped sections 11, 13 of the connecting channels 9. The slots, which are in the form of grooves and are open towards the second plate plane E2, may belong to a further distribution network 18 which is coherent in itself, the further distribution network 18 existing independently of the distribution network 17 and being correspondingly spatially separated from the latter. In order to be able to connect the manifold plate 1 to upstream components, such as extruders, and downstream components, such as further manifold plates or extrusion heads, due to structural, spatial conditions, the distribution networks 17, 18 can be arranged, respectively aligned differently, especially in the area of the mass inlets and in the area of the outlet channels.

The manifold plate 1 has its own mass inlet 19 for the further distribution network 18, which here can also be arranged in the front face 6 of the manifold plate 1, adjacent to the mass inlet 5. An inlet groove 20 is machined into the second plate side 3, through which a thermoplastic plastic melt can flow in one flow direction. The inlet groove 20 starts at the further mass inlet 19, to which another extruder can be connected. In the flow direction, the inlet groove 20 branches in the second plate plane E2 in the manner of a tree structure into several, here exemplarily ten, distribution grooves 21, which are machined into the second plate side 3. The distribution grooves 21 in the second plate side 3 and the distribution grooves 7 in the first plate side 2 are, here exemplarily, congruent.

The distribution grooves 21 each branch at a branch point 22 into two connection grooves 23, which are milled into the second plate side 3. The connection grooves 23 are designed to cover the section of the distribution grooves 7, which is designed as a groove, of a further manifold plate 1 which can be arranged underneath. That is, the connection grooves 23 may cover, from the distribution grooves 7, the respective inlet section 11 and the inlet-side section 13 of the first curved section 12 of the in the first plate side 2 of the adjacent manifold plate 1. In FIG. 2, it can be seen that the groove-shaped sections 11, 13 of the connecting channels 9 incorporated in the first plate side 2 spread further apart from one another than the connection grooves 23 incorporated in the second plate side 3, which cover the groove-shaped sections 11, 13 of a further manifold plate 1 that can be arranged thereunder. In FIG. 2, for reasons of clarity, only a subset of the reference signs 7, 8, 9, 10, 21, 22, 23 are shown as representative of the total set of these reference signs.

FIGS. 1 and 2 further show that a portion of a third inlet groove 24 may be machined, or milled, into the manifold plate 1. The inlet groove 24 begins, in the flow direction, at still another mass inlet 25, which may be located in the front face 6 of the manifold plate 1, and ends in the second plate side 3. The inlet groove 24 may be continued in another manifold plate 1 which may be arranged therebelow. A separate extruder can be connected via the additional mass inlet 25, so that thermoplastic plastic melt can be fed to an additional, here third, distribution network 26.

For the manufacture of the manifold plate 1, a workpiece 27, in particular a metallic workpiece, can be provided which may already have the basic shape of the manifold plate 1. The workpiece 27 may be a quenched and tempered tool steel. A CNC machining center 28, in particular a 5-axis CNC machining center, of which only a partial section is shown in FIGS. 4 and 5, can be used to machine the grooves 4, 7, 20, 21, 23 and the connecting channels 9 into the manifold plate 1.

In a manner known per se, the CNC machining center 28 can have a unit carrier with, among other things, a milling spindle 29 as well as a machine table (not shown) on which the workpiece 27 can be clamped. The milling spindle 29 drives a milling tool 30 in rotation around a spindle axis S. The milling tool 30 has a clamping shaft 31 and a working area, respectively a milling head 32. The clamping shaft 31 can be clamped in a receptacle of the spindle 29. The milling head 32 can be used to subject the workpiece 27 to a milling operation. The milling head 32 can be spherical. A diameter of the milling head 32 is to be selected smaller than a channel diameter of the connecting channel 9 to be produced, so that the milling head 32 can cut itself free.

In path-controlled form milling, the connecting channels 9 are milled into the workpiece 27 with a controlled engagement path. The milling spindle 29 with the milling tool 30 and the workpiece 27 clamped on the machine table are moved relative to each other, as shown in FIG. 5. Therein, one relative working position of the milling tool 30 and the workpiece 27 is shown with solid lines and three other relative working positions are shown with dashed lines. Relative to the workpiece 27, the spindle axis S traverses the lateral surface of a cone in order to be able to traverse the curved contact path past interfering edges 33. To ensure radial infeed of the milling head 32, the milling cutter center path can be helical, as shown in FIG. 5. The spiral movement prevents the front face of the milling head 32 from touching the workpiece 27. In the case of steep adjustment, as shown in FIG. 3 with the solid line of the milling spindle 29, the milling tool 30 abuts with the clamping shaft 31 against the interfering edges 33. In this respect, a first section of the respective connecting channel 9 can first be milled into the workpiece 27 starting from the first plate side 2. The first section may include a section of the transition section 14 in addition to the inlet section 11 and the first curved section 12.

After the grooves 4, 7 and the first sections of the connecting channels 9 have been milled into the manifold plate 1 starting from the first plate side 2, the second plate side 3 can be machined. For this purpose, the workpiece 27 can be reclamped on the machine table. In an analogous manner, the grooves 20, 21 and the second sections of the connecting channels 9 can be machined into the manifold plate 1 starting from the second plate side 3. In addition to the outlet section 16 and the second curved section 15, the second section of the respective connecting channel 9 may also comprise a section of the transition section 14.

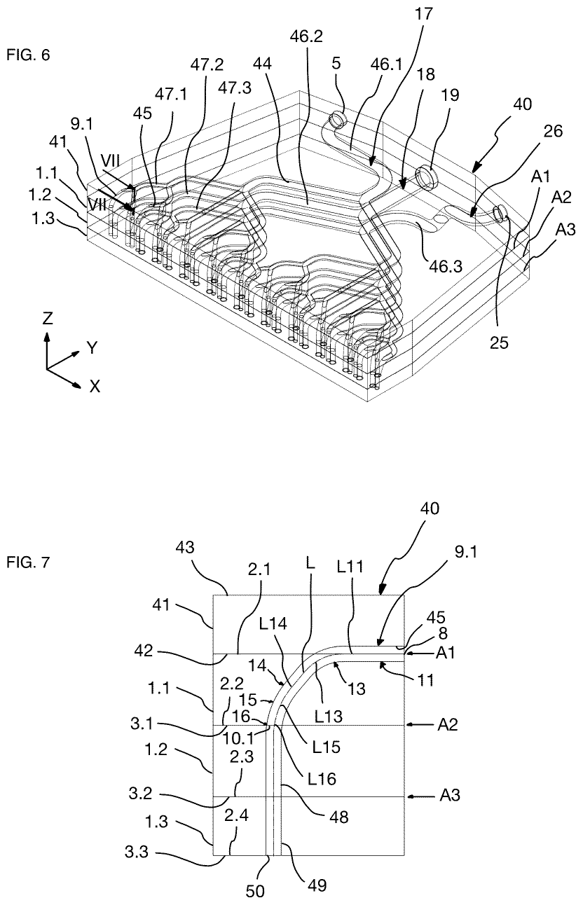

FIGS. 6 to 9 show a manifold 40 according to one embodiment. The manifold 40 is designed for feeding thermoplastic plastic melt to, here exemplarily ten, extrusion heads for producing a, here exemplarily three-layer, preform.

The manifold 40 comprises a plate pack with, here exemplarily four, manifold plates arranged one above the other, each of which rests against the other along a parting plane A1, A2, A3. Looking at FIG. 6, the uppermost plate is a cover plate 41, which has grooves on an inner plate side 42 through which the thermoplastic plastic melt can flow. An outer plate side 43 is flat or smooth. The basic shape of the cover plate 41 corresponds to that of the three manifold plates 1. A first manifold plate 1.1, a second manifold plate 1.2 and a third manifold plate 1.3 are arranged below the cover plate 41. The first and second manifold plates 1.1, 1.2 have the grooves through which the thermoplastic plastic melt can flow both on their first plate side 2.1, 2.2 and on their second plate side 3.1, 3.2. The manifold plates 1.1 and 1.2 are designed as described above, so that reference is made to the above description in this respect. The same or modified details are marked with the same reference signs as in FIGS. 1 to 5. The third manifold plate 1.3 closes off the plate pack at the bottom and accordingly has the grooves through which the thermoplastic plastic melt can flow only on its first plate side 2.3. In this respect, the third manifold plate 1.3 is designed as described above, with the exception that no grooves through which the thermoplastic plastic melt can flow are formed in the second plate side 3.3.

To illustrate the orientation of the manifold 40 in space, spatial axes X, Y, Z are defined in terms of a Cartesian coordinate system associated with the manifold 40 and indicated by corresponding arrows. The manifold 40 extends with its width along a spatial axis X, its depth along a spatial axis Y, and its height along a spatial axis Z.

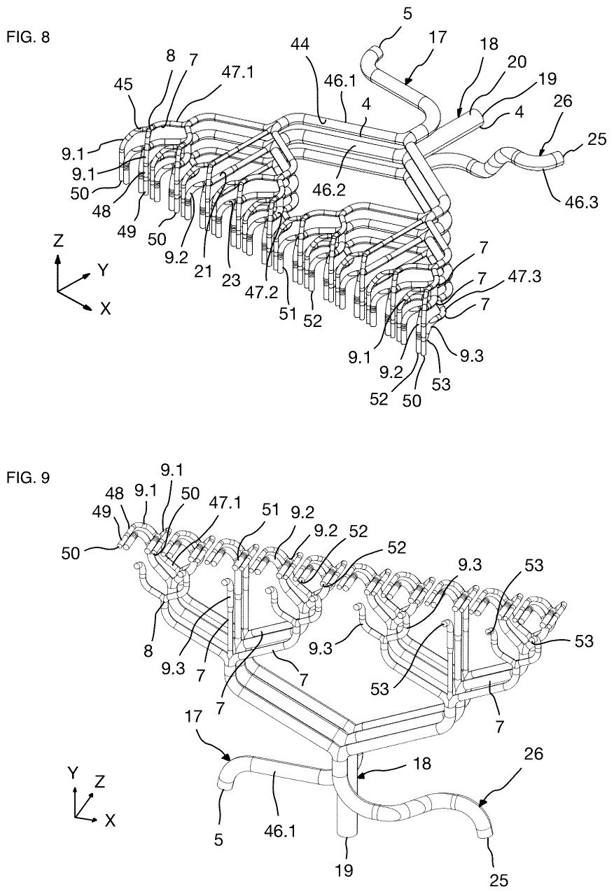

Grooves 44, 45 are machined, respectively, into the inner plate side 42 of the cover plate 41, which grooves coincide with the grooves 4, 7 machined into the first plate side 2.1 of the first manifold plate 1.1 as well as the machined groove-shaped sections 11, 13 of the connecting channels 9.1. The grooves 44 of the cover plate 41 and the grooves 4, 7 of the first manifold plate 1.1 thus together form a circumferentially closed inlet channel 46.1 and circumferentially closed distribution channels 47.1, as shown in particular in FIGS. 8 and 9. Their channel axes, around which the channels 46.1, 47.1 are circumferentially closed, extend in the parting plane A1. The inlet channel 46.1 can be connected to the first extruder via the first mass inlet 5. The distribution channels 47.1 are each adjoined by two of the connecting channels 9.1, which divert the thermoplastic plastic melt flowing through the distribution channels 47.1 out of the parting plane A1 by 90 degrees towards the second parting plane A2. For clarity, only a subset of the reference signs are shown in FIGS. 6 and 7.

In FIG. 7, it can be seen that the respective groove 45 machined in the inner plate side 42 of the cover plate 41 covers the groove-shaped section 11, 13 of the respective connecting channel 9.1. Along the groove-shaped inlet section 11 of the respective connecting channel 9.1, the groove 45 extends parallel to the parting plane A1 and approaches the first parting plane A1 in a continuously curved manner along the groove-shaped partial section 13 in the flow direction. The radius of curvature corresponds to that of the course line L in the first curved section 12. The groove-shaped section 11, 13 of the respective connecting channel 9.1 is thus formed closed by the respective groove 45 in the circumferential direction around the course line L. The course line L of the respective connecting channel 9.1 thus extends in the inlet section 11 in the parting plane A1 (straight course L11) and changes in the first curved section 12 into the curved course L12 towards the second parting plane A2. After a 90 degree deflection, which is reached at the end of the second curved section 15, the course line L in the outlet section 16 extends perpendicular to the parting planes A1, A2 (straight course L16).

Bores 48, 49 are formed in the subsequent manifold plates 1.2, 1.3 in alignment with the outlet openings 10.1 of the first manifold plate 1.1, which extend perpendicular to the plate sides 2, 3. The extrusion heads can be connected to the manifold 40 at the, here exemplarily twenty, holes 49 in the third manifold plate 1.3. For example, if each extrusion head is to be supplied with thermoplastic plastic melt via two of the bores 49, which can open in pairs, for example, into a heart curve of the respective extrusion head, ten extrusion heads can be connected to the first distribution network 17 in this way. In particular, it can be seen in FIGS. 8 and 9 that the first distribution network 17 starts in the first parting plane A1 and extends from the first mass inlet 5 through the inlet channel 46.1, the distribution channels 47.1, the connecting channels 9.1 and the holes 48, 49 and ends in twenty connection points 50 formed in the second plate side 3.3 of the third manifold plate 1.3. The first distribution network 17 thus divides the thermoplastic plastic melt that can be conveyed by the first extruder into, here exemplarily, twenty melt streams of equal size, which can be fed to, here exemplarily, ten extrusion heads.

In an analogous manner, circumferentially closed channels 46.2, 47.2 are formed between the second plate side 3.1 of the first manifold plate 1.1 and the first plate side 2.2 of the second manifold plate 1.2, which extend in the parting plane A2 and merge downstream into the connecting channels 9.2 of the second manifold plate 1.2. In the following manifold plate 1.3, bores 51 are formed in alignment with the outlet openings 10.2 of the second manifold plate 1.2, which extend perpendicular to the plate sides 2, 3. In particular, it can be seen in FIGS. 8 and 9 that the second distribution network 18 starts in the second parting plane A2 and extends from the second mass inlet 19 through the inlet channel 46.2, the distribution channels 47.2, the connecting channels 9.2 and the holes 51, and ends in twenty connection points 52 in the second plate side 3.3 of the third manifold plate 1.3. The second distribution network 18 thus divides the thermoplastic plastic melt that can be conveyed by the second extruder into, here exemplarily, twenty melt streams of equal size that can be fed, here exemplarily, to the ten extrusion heads.

In an analogous manner, circumferentially closed channels 46.3, 47.3 are formed between the second plate side 3.2 of the second manifold plate 1.2 and the first plate side 2.3 of the third manifold plate 1.3, which extend in the third parting plane A3 and merge downstream into the connecting channels 9.3 of the third manifold plate 1.3. The third distribution network 26 differs from the other two distribution networks 17, 18, exemplified here, in that one connecting channel 9.3 is provided for each extrusion head. FIG. 9 shows that four of the distribution channels 47.3 branch into two of the connecting channels 9.3 each and two of the distribution channels 7.3 branch into exactly one of the connecting channels 9.3 each. Accordingly, the connecting channels 9.3 in the second plate side 3.3 of the third manifold plate 1.3 end at ten connection points 53. In addition, the connecting channels 9.3 do not perform a 90 degree deflection, but a deflection of, in this case, about 20 degrees from the parting plane A3 to the second plate side 3.3 of the third manifold plate 1.3. In principle, however, deflections through the connecting channels 9.3 between 1 degree and 89 degrees are conceivable and possible. In this way, the interfaces of the ten extruders for the third distribution network 26 can be positioned at an angle to the second plate plane E2 of the third manifold plate 1.3 at the connection points 53, as shown in connection with the extrusion assembly according to the invention in FIG. 11. In FIG. 9 it can be seen that the connection points 50, 52 are arranged on an imaginary first straight line, whereas the connection points 53 are arranged at a distance from the first straight line on an imaginary second straight line which is parallel to the first straight line.

The third distribution network 26 begins, here exemplarily, in the first parting plane A1, in which the third mass inlet 25 is located. This is arranged here only as an example in the first parting plane A1. In principle, at least one of the mass inlets 5, 17, 25 can also be arranged at a different location of the manifold 40 if the structural specifications, positioning of the interfaces to the extruders, or space conditions of the extrusion assembly require it. In particular, it can be seen in FIGS. 8 and 9 that the third distribution network 26 extends from the third mass inlet 25 via the inlet channel 46.3, which here extends through the second manifold plate 1.2 into the third parting plane A3, the distribution channels 47.3 extending in the third parting plane A3, and the connecting channels 9.3, and ends in the, here, ten connection points 53 in the second plate side 3.2 of the third manifold plate 1.3. The third distribution network 25 thus divides the thermoplastic plastic melt that can be supplied by the third extruder into, here exemplarily, ten melt streams of equal size, which can be fed, here exemplarily, to the ten extrusion heads.

By means of the manifold 40 shown as an example, which, in this case, has three manifold plates 1.1, 1.2, 1.3 and the cover plate 41, a total of ten extrusion heads can thus be connected to the manifold 40 for the production of three-layer preforms. If the preforms to be produced are to be extruded with more than three layers, the manifold 40 can be supplemented with additional manifold plates 1. Likewise, the manifold 40 can extrude preforms with two layers or only one layer, for which the manifold 40 then accordingly has only two of the manifold plates 1 or only one of the manifold plates 1 and the cover plate 41.

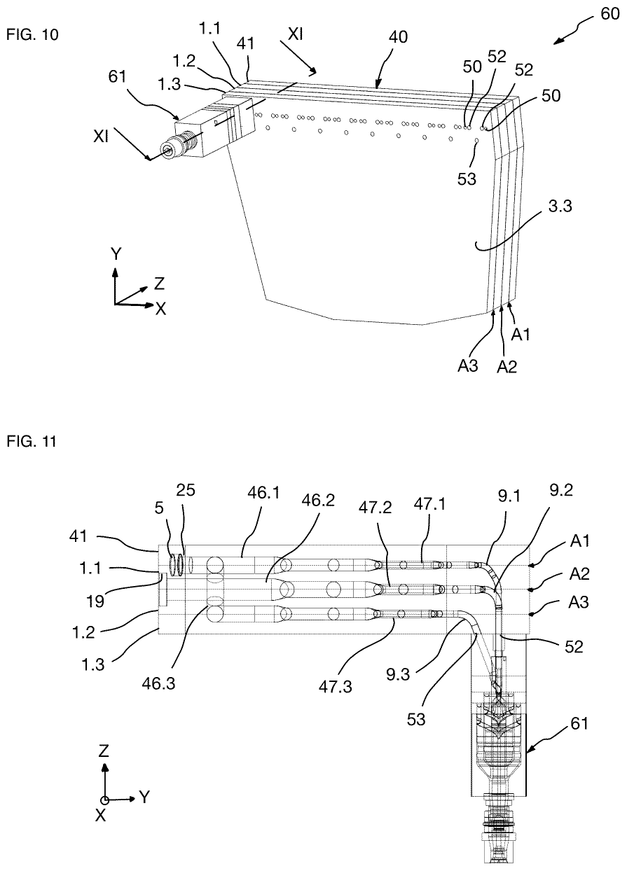

FIGS. 10 and 11 show an extrusion assembly 60 according to one embodiment. The extrusion assembly 60 includes the manifold 40 and ten extrusion heads 61. In FIG. 10, only one of the extrusion heads 61 is shown in order to show the connection points 50, 52, 53 formed in the second plate side 3.3 of the third manifold plate 1.3. Each of the extrusion heads 61 is connectable to the first extruder (not shown) via two of the connection points 50 of the first distribution network 17, to the second extruder (not shown) via two of the connection points 52 of the second distribution network 18, and to the third extruder (not shown) via one of the connection points 53 of the third distribution network 26, in order to be able to extrude, in this case, three-layer preforms.

To illustrate the orientation of the extrusion assembly 60 in space, spatial axes X, Y, Z are defined in terms of a Cartesian coordinate system associated with the extrusion assembly 60 and indicated by corresponding arrows. The extrusion assembly 60 extends with its width along a spatial axis X, its depth along a spatial axis Y, and its height along a spatial axis Z. When installed in the extrusion assembly 60, the parting planes A1, A2, A3 between the manifold plates 1 are preferably horizontally oriented.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A manifold plate for a manifold for supplying thermoplastic plastic melt to at least one extrusion head for producing a preform, the manifold plate comprising:
a first plate side and a second plate side;
a distribution groove formed in the first plate side and extending in a plate plane of the first plate side; and
at least one connecting channel adjoining the distribution groove, said at least one connecting channel is incorporated in the manifold plate and ends at an outlet opening in the second plate side, and said at least one connecting channel is milled into the manifold plate and, in the flow direction, has a course which is curved at least partially towards the second plate side.

2. The manifold plate according to claim 1, wherein the at least one connecting channel defines a course line and has a curved section, the course line in the curved section being curved in the flow direction towards the second plate side.

3. The manifold plate according to claim 2, wherein the curved section of the at least one connecting channel is formed on an inlet side as a groove open perpendicular to the course line and on an outlet side as a conduit closed in the circumferential direction around the course line.

4. The manifold plate according to claim 2, wherein the at least one connecting channel has, upstream of the curved section, an inlet section extending in the plate plane of the first plate side, the inlet section being designed as a groove open to the plate plane of the first plate side.

5. The manifold plate according to claim 2, wherein a tangent to the course line in the curved section encloses an angle of greater than 0 degrees and less than 60 degrees with the plate plane of the first plate side.

6. The manifold plate according to claim 2, wherein the at least one connecting channel has, downstream of the curved section, a further curved section in which the course line is curved in the flow direction towards the second plate side.

7. The manifold plate according to claim 6, wherein the at least one connecting channel has a transition section between the curved section and the further curved section, in which the course line is straight.

8. The manifold plate according claim 2, wherein the at least one connecting channel has an outlet section ending at the outlet opening, the course line in the outlet section being straight and extending transversely to the first plate side.

9. The manifold plate according to claim 1, wherein the first plate side and the second plate side are outer sides of the manifold plate facing away from each other.

10. The manifold plate according to claim 1, wherein the distribution groove divides into exactly one or two of the connecting channels.

11. The manifold plate according to claim 1, wherein the manifold plate has one of the distribution grooves per extrusion head.

12. A manifold for supplying thermoplastic plastic melt to at least one extrusion head for producing a preform, the manifold comprising at least one manifold plate according to claim 1 and a cover plate.

13. An extrusion assembly comprising a manifold according to claim 12 and at least one extrusion head for producing a preform.

14. A method of manufacturing a manifold plate according to claim 1, the method comprising the steps of:
working a distribution groove in a first plate side of a workpiece; and
working at least one connecting channel into the workpiece by path-controlled form milling, a milling head being moved, starting from the first plate side, at least partially on a path curved towards a second plate side.

15. The method according to claim 14, wherein a first section of the at least one connecting channel starting from the first plate side and a second section of the at least one connecting channel starting from the second plate side are worked into the workpiece by path-controlled form milling.
